(19) United States
(12) Patent Application Publication
(10) Pub. No.: US 2022/0247453 A1
(43) Pub. Date: Aug. 4, 2022

(54) COIL COMPONENT AND MOBILE TERMINAL HOLDER HAVING THE SAME

(71) Applicant: TDK Corporation, Tokyo (JP)

(72) Inventors: Noritaka CHIYO, Tokyo (JP); Takuya YOSHIDA, Tokyo (JP); Michihisa TOKUI, Tokyo (JP); Tomohiro MORIKI, Tokyo (JP); Takahiro OHISHI, Tokyo (JP)

(73) Assignee: TDK Corporation, Tokyo (JP)

(21) Appl. No.: 17/575,223

(22) Filed: Jan. 13, 2022

(30) Foreign Application Priority Data
Jan. 29, 2021 (JP) 2021-013317

(51) Int. Cl. H04B 5/00; H02J 50/12

(52) U.S. Cl. CPC H04B 5/0081; H04B 5/0037; H02J 50/12

(57) ABSTRACT

Disclosed herein is a coil component that includes a first coil pattern, wherein an opening area surrounded by the first coil pattern has a first side extending in a first direction and a second side extending in the first direction, and wherein the first side is longer than the second side.

### CROSS-REFERENCE TO RELATED APPLICATION

This application claims the benefit of Japanese Patent Application No. 2021-013317, filed on Jan. 29, 2021, the entire disclosure of which is incorporated by reference herein.

### BACKGROUND

### Field

The present disclosure relates to a coil component and a mobile terminal holder having the same.

### Description of Related Art

A coil component having a spiral-shaped winding can be used as a transmitting/receiving coil used for a wireless power transmitting device and an antenna coil used for near-field communication (NFC). Coil components of this type can have not only a circular pattern shape but also various pattern shapes. For example, JP 2015-231329A proposes an example in which a wire is wound in an isosceles triangle shape, and JP 2017-135828A proposes an example in which a coil has a trapezoidal outer shape.

However, in the example described in JP 2015-231329A, a slight change in the relative position between a power transmitting coil and a power receiving coil near the vertex of the isosceles triangle causes a large change in power transmission efficiency. Further, in the example described in JP 2017-135828A, the coil shape has a small opening area, and thus power transmission efficiency is low.

### SUMMARY

It is therefore an object of the present disclosure to provide an improved coil component and a mobile terminal holder having such a coil component.

A coil component according to one embodiment of the present disclosure includes a first coil pattern. An opening area surrounded by the first coil pattern has a first side extending in a first direction and a second side extending in the first direction. The first side is longer than the second side.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view illustrating the outer shape of a mobile terminal holder 1 incorporating a coil component 30 according to one embodiment;

FIG. 2 is a schematic view illustrating a state where a smartphone 10 or 20 is placed on the placing surface 2a of the mobile terminal holder 1;

FIG. 3 is a schematic cross-sectional view illustrating the configuration of the coil component 30;

FIG. 4 is a plan view for explaining the pattern shape of the first coil pattern 100, which is viewed from the surface 41 side of the substrate 40;

FIG. 5 is a plan view for explaining the pattern shape of the second coil pattern 200, seen through from the surface 41 side of the substrate 40;

FIG. 6 is an equivalent circuit diagram of the coil component 30;

FIG. 7 is a schematic cross-sectional view of the coil component 30;

FIG. 8 is a schematic plan view for explaining the outer shape and inner shape of each of the first and second coil patterns 100 and 200;

FIG. 9 is a schematic diagram for explaining a definition of a length L1;

FIG. 10 is a block diagram of a wireless power transmitting device 60 including the coil component 30 according to the present embodiment; and

FIGS. 11A to 11C are tables showing characteristics of the examples.

### DETAILED DESCRIPTION OF THE EMBODIMENTS

Preferred embodiments of the present disclosure will be explained below in detail with reference to the accompanying drawings.

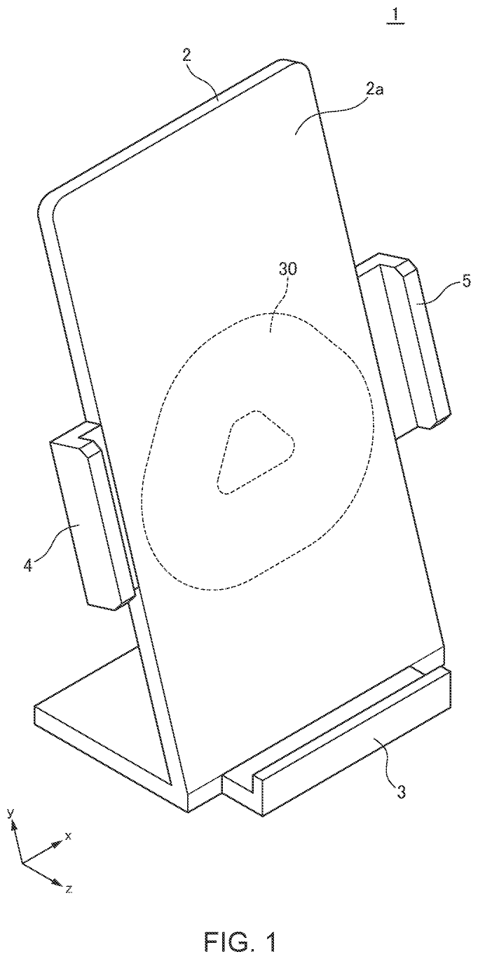

FIG. 1 is a schematic perspective view illustrating the outer shape of a mobile terminal holder 1 incorporating a coil component 30 according to one embodiment.

The mobile terminal holder 1 illustrated in FIG. 1 includes a main body part 2 having a placing surface 2a on which a mobile terminal such as a smartphone is placed, a lower stopper 3 for regulating the y-direction position of the mobile terminal on the placing surface 2a, and left and right stoppers 4 and 5 for regulating the x-direction position of the mobile terminal. The placing surface 2a has an xy plane. The replacing surface 2a is inclined, so that, when the mobile terminal is placed on the placing surface 2a, it abuts at its lower end against the lower stopper 3 by its own weight, whereby the mobile terminal is positioned in the y-direction. As for the x-direction, the mobile terminal is set at any position between the left and right stoppers 4 and 5. The x-direction is an example of a first direction, and the y-direction is an example of a second direction.

A power transmitting coil component 30 for wireless power transmission is disposed below (in the z-direction) the replacing surface 2a. Thus, placing a mobile terminal such as a smartphone on the mobile terminal holder 1 allows the mobile terminal to be charged through wireless power transmission. The device incorporating the coil component according to the present disclosure is not limited to the mobile terminal holder 1 illustrated in FIG. 1 but may be any device capable of placing thereon a mobile terminal, such as the center console provided in a vehicle.

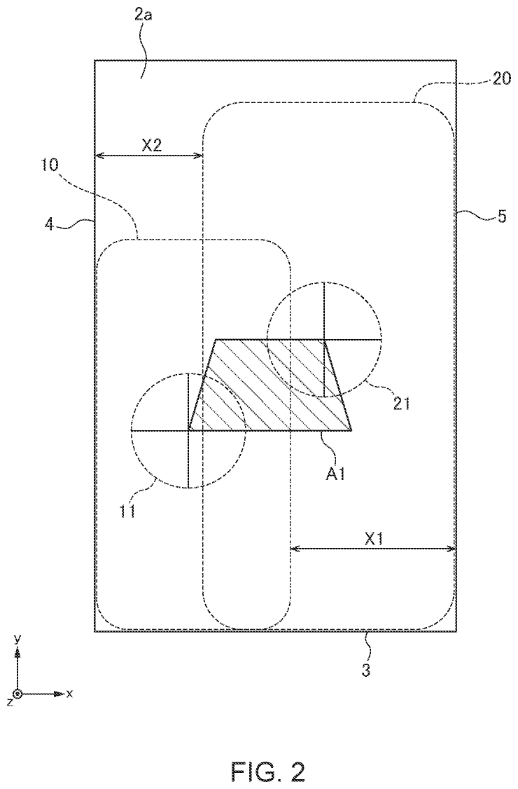

FIG. 2 is a schematic view illustrating a state where a smartphone 10 or 20 is placed on the placing surface 2a of the mobile terminal holder 1.

As illustrated in FIG. 2, the smartphone 10 is relatively small, while the smartphone 20 is relatively large. The small-sized smartphone 10 is disposed at the leftmost side so as to contact the left stopper 4, and the large-sized smartphone 20 is disposed at the rightmost side so as to contact the right stopper 5. The position of the smartphone 10 in the x-direction can vary in the range of X1, and the position of the smartphone 20 in the x-direction can vary in the range of X2. As for the y-direction, the smartphones 10 and 20 are affected by the gravity and are thus positioned by the lower stopper 3.

Here, assume that the size of the smartphone 10 is the minimum size to be placed on the mobile terminal holder 1 and that the size of the smartphone 20 is the maximum size to be placed on the mobile terminal holder 1. In this case, in the smartphones 10 and 20 each incorporating a power receiving coil for wireless power transmission at substantially the center portion, the center positions of receiving coils 11 and 22 fall within the range of the trapezoidal area A1 illustrated in FIG. 2. The lengths of the lower and upper sides of the trapezoidal area A1 are X1 and X2, respectively. Thus, the position and shape of the coil component 30 to be incorporated in the mobile terminal holder 1 are desirably designed assuming that the center position of the power receiving coil can vary in the range of the trapezoidal area A1.

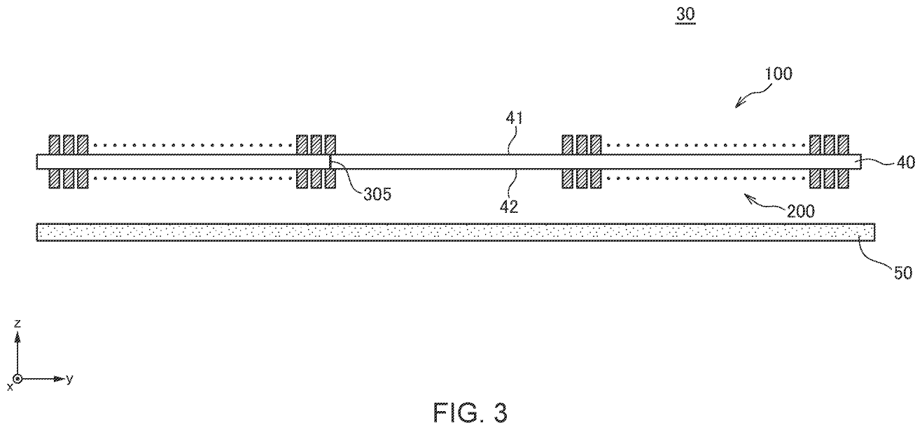

FIG. 3 is a schematic cross-sectional view illustrating the configuration of the coil component 30.

The coil component 30 illustrated in FIG. 3 includes a substrate 40, a first coil pattern 100 formed on one surface 41 of the substrate 40, and a second coil pattern 200 formed on the other surface 42 of the substrate 40. Although details will be described later, the inner peripheral end of the first coil pattern 100 and the inner peripheral end of the second coil pattern 200 are connected to each other through a plurality of through-hole conductors (only a through-hole conductor 305 appears in the cross section of FIG. 3) penetrating the substrate 40. The coil component 30 is embedded in the main body part 2 such that the surface 41 of the substrate 40 faces the placing surface 2a. That is, the coil component 30 is mounted in the main body part 2 such that the axial direction of each of the first and second coil patterns 100 and 200 is perpendicular to the placing surface 2a. A magnetic sheet 50 made of a magnetic material such as ferrite is preferably disposed on the surface 42 of the substrate 40.

Although there is no particular restriction on the material of the substrate 40, a transparent or translucent flexible insulating material, such as PET resin, can be used. Alternatively, the substrate 40 may be a flexible substrate obtained by impregnating glass cloth with epoxy-based resin.

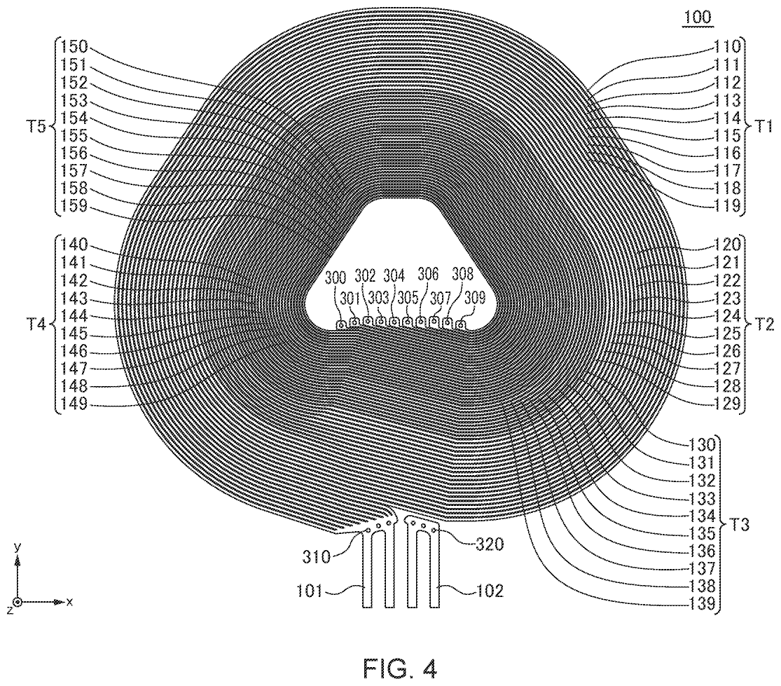

FIG. 4 is a plan view for explaining the pattern shape of the first coil pattern 100, which is viewed from the surface 41 side of the substrate 40.

The first coil pattern 100 has a five-turn configuration constituted of turns T1 to T5. The turn T1 is positioned at the outermost periphery, and turn T5 is positioned at the innermost periphery. The turns T1 to T5 are each divided into 10 lines by nine spiral slits. Specifically, the turn T1 is divided into 10 lines, 110 to 119, the turn T2 is divided into 10 lines, 120 to 129, the turn T3 is divided into 10 lines, 130 to 139, the turn T4 is divided into 10 lines, 140 to 149, and the turn T5 is divided into 10 lines, 150 to 159.

The lines 110, 120, 130, 140, and 150 constitute a continuous line spirally wound in five turns, the lines 111, 121, 131, 141, and 151 constitute a continuous line spirally wound in five turns, the lines 112, 122, 132, 142, and 152 constitute a continuous line spirally wound in five turns, the lines 113, 123, 133, 143, and 153 constitute a continuous line spirally wound in five turns, the lines 114, 124, 134, 144, and 154 constitute a continuous line spirally wound in five turns, the lines 115, 125, 135, 145, and 155 constitute a continuous line spirally wound in five turns, the lines 116, 126, 136, 146, and 156 constitute a continuous line spirally wound in five turns, the lines 117, 127, 137, 147, and 157 constitute a continuous line spirally wound in five turns, the lines 118, 128, 138, 148, and 158 constitute a continuous line spirally wound in five turns, and the lines 119, 129, 139, 149, and 159 constitute a continuous line spirally wound in five turns. The lines 110, 120, 130, 140, and 150 are lines positioned at the outermost peripheries of their corresponding turns, and the lines 119, 129, 139, 149, and 159 are lines positioned at the innermost peripheries of their corresponding turns.

The outer peripheral ends of the lines 110 to 119 are connected in common to a first terminal electrode pattern 101. The innermost peripheral ends of the lines 150 to 159 are connected respectively to through-hole conductors 300 to 309 penetrating the substrate 40. A second terminal electrode pattern 102 is formed on the surface 41 of the substrate 40 separately from the first coil pattern 100.

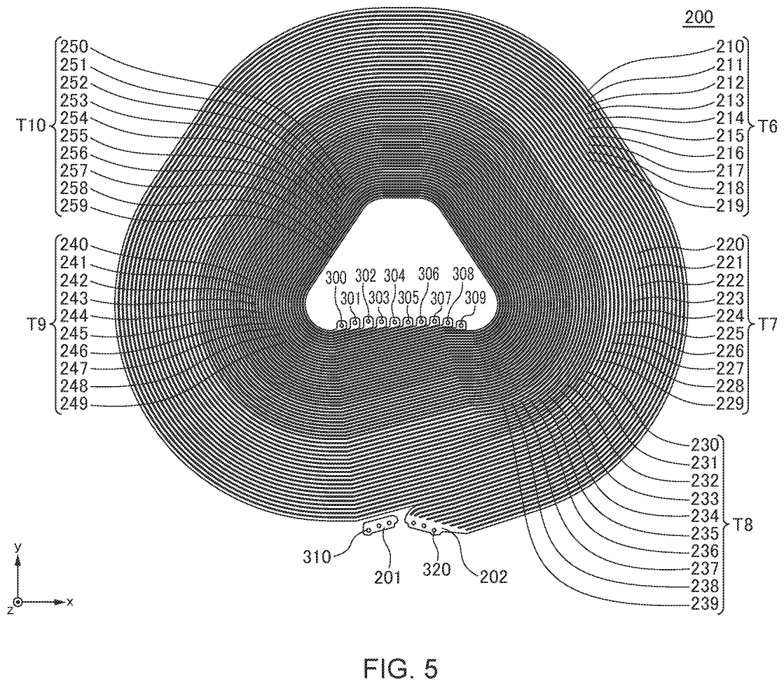

FIG. 5 is a plan view for explaining the pattern shape of the second coil pattern 200, seen through from the surface 41 side of the substrate 40.

The second coil pattern 200 has a five-turn configuration constituted of turns T6 to T10. The turn T6 is positioned at the outermost periphery, and the turn T10 is positioned at the innermost periphery. The turns T6 to T10 are each divided into 10 lines by nine spiral slits. Specifically, the turn T6 is divided into 10 lines, 210 to 219, the turn T7 is divided into 10 lines, 220 to 229, the turn T8 is divided into 10 lines, 230 to 239, the turn T9 is divided into 10 lines, 240 to 249, and the turn T10 is divided into 10 lines, 250 to 259.

The lines 210, 220, 230, 240, and 250 constitute a continuous line spirally wound in five turns, the lines 211, 221, 231, 241, and 251 constitute a continuous line spirally wound in five turns, the lines 212, 222, 232, 242, and 252 constitute a continuous line spirally wound in five turns, the lines 213, 223, 233, 243, and 253 constitute a continuous line spirally wound in five turns, the lines 214, 224, 234, 244, and 254 constitute a continuous line spirally wound in five turns, the lines 215, 225, 235, 245, and 255 constitute a continuous line spirally wound in five turns, the lines 216, 226, 236, 246, and 256 constitute a continuous line spirally wound in five turns, the lines 217, 227, 237, 247, and 257 constitute a continuous line spirally wound in five turns, the lines 218, 228, 238, 248, and 258 constitute a continuous line spirally wound in five turns, and the lines 219, 229, 239, 249, and 259 constitute a continuous line spirally wound in five turns. The lines 210, 220, 230, 240, and 250 are lines positioned at the outermost peripheries of their corresponding turns, and the lines 219, 229, 239, 249, and 259 are lines positioned at the innermost peripheries of their corresponding turns.

The outer peripheral ends of the lines 210 to 219 are connected in common to a common pattern 202. The common pattern 202 is connected to the second terminal electrode pattern 102 through a plurality of through-hole conductors 320 penetrating the substrate 40. The innermost peripheral ends of the lines 259, 258, 257, 256, 255, 254, 253, 252, 251, and 250 are connected respectively to the inner peripheral ends of the lines 150 to 159 through the through-hole conductors 300 to 309. A dummy pattern 201 is formed on the surface 42 of the substrate 40 separately from the second coil pattern 200. The dummy pattern 201 is connected to the first terminal electrode pattern 101 through a plurality of through-hole conductors 310 penetrating the substrate 40.

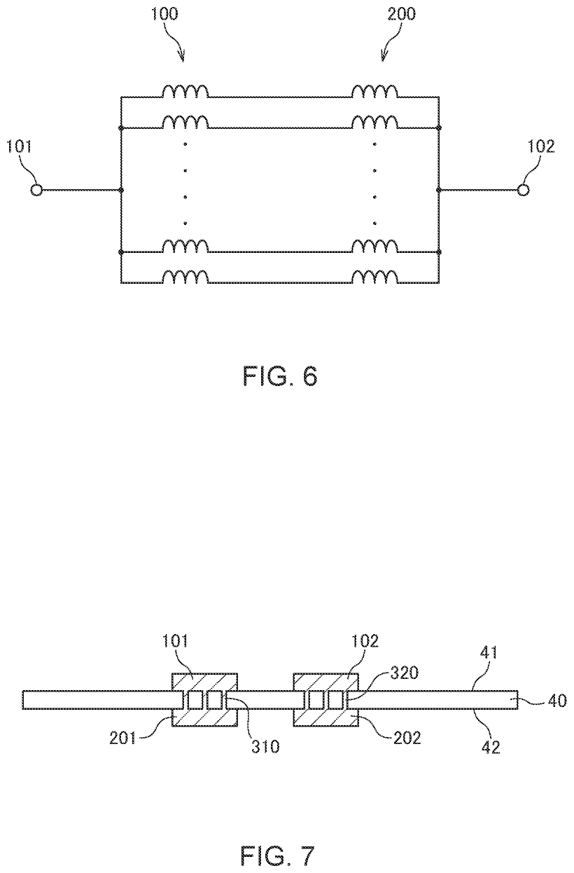

Thus, as illustrated in FIG. 6, the first and second coil patterns 100 and 200 are connected in series between the first and second terminal electrode patterns 101 and 102. Since the first coil pattern 100 has a five-turn configuration constituted of the turns T1 to T5, and the second coil pattern 200 has a five-turn configuration constituted of the turns T6 to T10, a coil having a 10-turn configuration in total is obtained. In addition, the outermost peripheral lines 110, 120, 130, 140, and 150 are connected respectively to the innermost peripheral lines 219, 229, 239, 249, and 259, and the innermost peripheral lines 119, 129, 139, 149, and 159 are connected respectively to the outermost peripheral lines 210, 220, 230, 240, and 250, whereby inner and outer peripheral difference is eliminated.

Further, as illustrated in the schematic cross-sectional view of FIG. 7, the first terminal electrode pattern 101 formed on the surface 41 of the substrate 40 is connected to the dummy pattern 201 formed on the surface 42 of the substrate 40 through the plurality of through-hole conductors 310, and thus the first terminal electrode pattern 101 is more firmly fixed to the surface 41 of the substrate 40, so that peeling is less apt to occur.

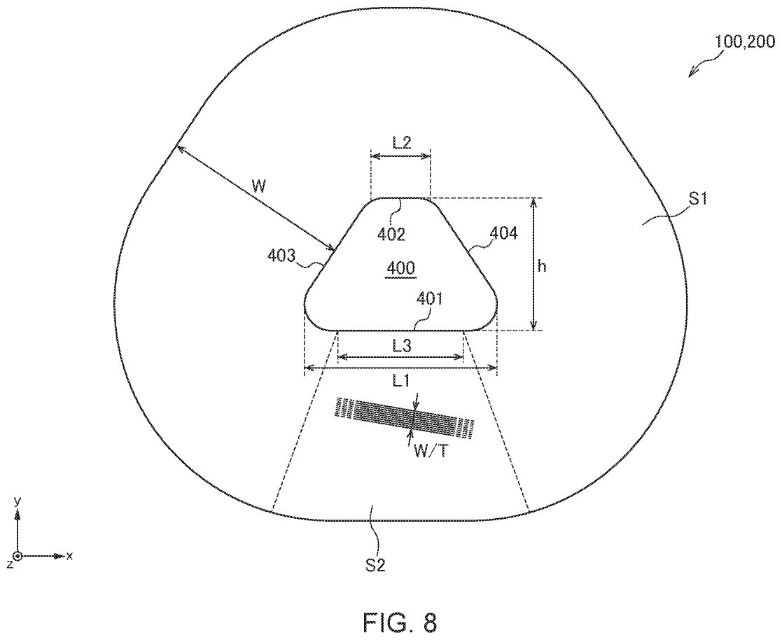

FIG. 8 is a schematic plan view for explaining the outer shape and inner shape of each of the first and second coil patterns 100 and 200. The term “outer shape” refers to the shape along the outer peripheral edges of the outermost peripheral lines 110 and 210, and the term “inner shape” refers to the shape along the inner peripheral edges of the innermost peripheral lines 159 and 259. However, at the outer peripheral portion where the lines 110 or 210 is absent, a part of the outer shape is constituted by the outer peripheral ends of the lines 111 to 119 or 211 to 219. Similarly, at the inner peripheral portion where the line 159 or 259 is absent, a part of the inner shape is constituted by the inner peripheral ends of the lines 150 to 158 or 250 to 258.

The first and second coil patterns 100 and 200 have the same shape and are formed on the front and back surfaces of the substrate 40 such that opening areas 400 thereof coincide with each other. The opening area 400 refers to the area surrounded by the coil pattern 100 or 200. The opening areas 400 of the coil patterns 100 and 200 are each substantially trapezoidal and each have a lower side 401 extending in the x-direction, an upper side 402 extending in the x-direction, a first oblique side 403 connecting one end of the lower side 401 and one end of the upper side 402, and a second oblique side 404 connecting the other end of the lower side 401 and the other end of the upper side 402. The opening area 400 need not be strictly trapezoidal, and the corners thereof may be rounded. The axial directions of the first and second coil patterns 100 and 200 are each orthogonal to the x- and y-directions. The lower side 401 is an example of a first side, the upper side 402 is an example of a second side, the first oblique side 403 is an example of a third side, and a second oblique side 404 is an example of a fourth side.

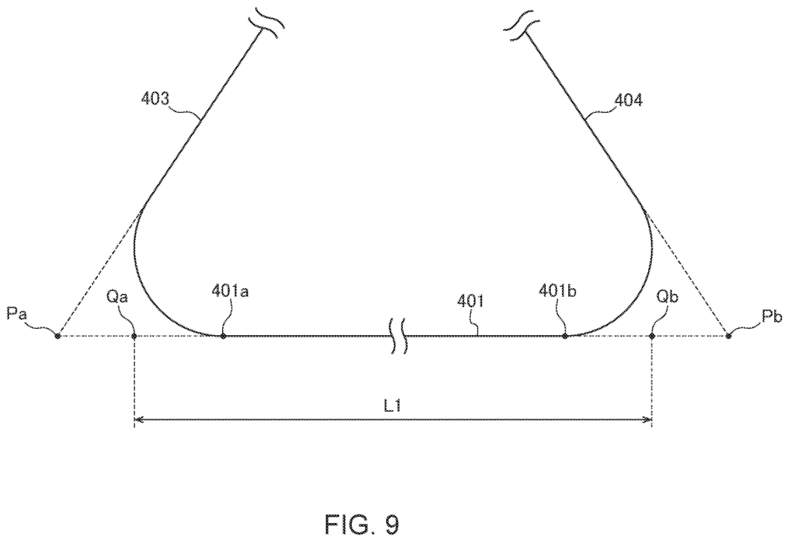

Assuming that the lengths of the lower and upper sides 401 and 402 are L1 and L2, respectively, L1>L2 is satisfied. When the corners of the opening area 400 are rounded, as illustrated in FIG. 9, end portions 401a and 401b of the linear portion of the lower side 401, an imaginary point Pa on the intersection between the extension line of the lower side 401 and oblique side 403, and an imaginary point Pb on the intersection between the extension line of the lower side 401 and oblique side 404 are defined, and the length L1 of the lower side 401 is defined by the distance between a midpoint Qa of the imaginary point Pa and end portion 401a and a midpoint Qb of the imaginary point Pb and end portion 401b. The length L2 of the upper side 402 is defined in the same way.

As described above, in the present embodiment, the opening area 400 of the coil component 30 is substantially trapezoidal, so that when the coil component 30 is incorporated in the main body part 2 of the mobile terminal holder 1 so as to locate the lower side 401 on the side of the lower stopper 3 illustrated in FIG. 1 and to locate the upper side 402 on the side opposite to the lower stopper 3, the trapezoidal area A1 that can be the center position of the power receiving coil and the opening area 400 of the coil component 30 for power transmission can be made to overlap each other. That is, the center position of the power receiving coil overlaps the opening area 400 of the coil component 30 without fail irrespective of the size and position of the smartphone placed on the mobile terminal holder 1, allowing high power transmission efficiency to be achieved.

To allow wireless power transmission irrespective of the size and position of the smartphone placed on the mobile terminal holder 1, enlarging the size of the power transmitting coil component 30 is the most simple method. However, simply enlarging the size of the coil component 30 fails to sufficiently enhance power transmission efficiency in a case where the relative displacement between the power receiving coil and the power transmitting coil is small. On the other hand, in the coil component 30 according to the present embodiment, the opening area 400 is designed to be substantially trapezoidal in conformity with the trapezoidal area A1 that can be the center position of the power receiving coil, thus allowing wireless power transmission irrespective of the size and position of the smartphone and achieving high power transmission efficiency in a case where the relative displacement between the power receiving coil and the power transmitting coil is small.

The angle formed by the lower side 401 and first oblique side 403 is preferably equal to the angle formed by the lower side 401 and second oblique side 404. This means that the trapezoidal area A1 is an isosceles trapezoid.

Assuming that the winding width of each of the coil patterns 100 and 200 is W, L1/W=0.8 to 1.2 is preferably satisfied. The winding width W refers to the radial distance from the outer peripheral edge of each of the outermost peripheral lines 110 and 210 to the inner peripheral edge of each of the innermost peripheral lines 159 and 259. The winding width W is almost constant. When the winding width W is not constant, the winding width W is measured from the oblique side 403 or 404 as illustrated in FIG. 8. When L1/W=0.8 to 1.2 is satisfied, the AC resistance values (ACRs) of the coil patterns 100 and 200 can be reduced. Further, the inter-coil coupling coefficient k between the coil patterns 100 and 200 and the power receiving coil can be increased due to compactness of the coil patterns 100 and 200.

Further, the relation between the length L1 of the lower side 401 and the length L2 of the upper side 402 preferably satisfies L1/L2=2.8 to 3.4. Further, assuming that the height of the opening area 400 in the y-direction is h, W/h=1.2 to 1.6 is preferably satisfied. With the above relations, the inter-coil coupling coefficient k with the power receiving coil can be increased. The height of the opening area 400 in the y-direction is an example of the length of the opening area in the second direction orthogonal to the first direction.

The turns T1 to T5 (T6 to T10) constituting the coil pattern 100 (200) each have a first section S1 extending along the upper side 402, first oblique side 403, and second oblique side 404 and a second section S2 extending along the lower side 401. As illustrated in FIGS. 4 and 5, the first section S1 extends in parallel to the upper side 402, first oblique side 403, and second oblique side 404, while the second section S2 has a part that extends obliquely to the lower side 401. This is because, when the outer and inner peripheral ends are set as the start point and the end point, respectively, each turn shifts inward to the next turn at the second section S2. In this section, the lines constituting each turn are closely disposed to one another for the radial shift. Thus, in the present embodiment, the second section S2 is located along the lower side 401 with a longer length, so that a sufficient pattern width can be allocated to each line that passes through the second section S2 as compared to when the second section S2 is located along the upper side 402. Assuming that the length of a part of the second section S2 that extends obliquely to the lower side 401 along the lower side 401 is L3 and that the number of turns of each of the coil patterns 100 and 200 is T, L3>W/T is satisfied. That is, L3 is larger than the winding width of each turn constituting the coil patterns 100 and 200. This allows a more sufficient pattern width to be allocated to each line that passes through the second section S2.

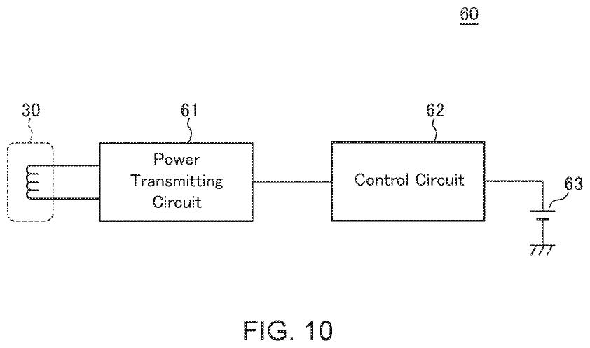

FIG. 10 is a block diagram of a wireless power transmitting device 60 including the coil component 30 according to the present embodiment.

The wireless power transmitting device 60 illustrated in FIG. 10 includes the coil component 30 described above, a power transmitting circuit 61 connected to the coil component 30 and a control circuit 62 connected to the power transmitting circuit 61. Thus, power supplied from a power supply 63 can be transmitted wirelessly to the smartphone 10 or 20 through the coil component 30 for wireless power transmission.

While the preferred embodiment of the present invention has been described, the present invention is not limited to the above embodiment, and various modifications may be made within the scope of the present invention, and all such modifications are included in the present invention.

The technology according to the present disclosure includes the following configuration examples, but not limited thereto.

A coil component according to one embodiment of the present disclosure includes a first coil pattern. An opening area surrounded by the first coil pattern has a first side extending in a first direction and a second side extending in the first direction. The first side is longer than the second side.

When the thus configured coil component is incorporated in a mobile terminal holder, a high magnetic coupling degree can be obtained irrespective of the size and position of the mobile terminal.

The opening area may further have a third side connecting one end of the first side and one end of the second side and a fourth side connecting the other end of the first side and the other end of the second side, and the angle formed by the first and third sides may be equal to the angle formed by the first and fourth sides. With this configuration, characteristics vary uniformly with respect to displacement in the left-right direction. In this case, each turn constituting the first coil pattern may have a first section extending along the second, third, and fourth sides and a second section extending along the first side. Further, the first section may extend in parallel to the second, third, and fourth sides, and the second section may have a part that extends obliquely to the first side. With this configuration, it is possible to ensure a sufficient area for the area where lines constituting each turn are closely disposed to one another in order for each turn to radially shift. In this case, the length of the part that extends obliquely along the first side may be larger than the winding width of each turn constituting the first coil pattern. This allows a more sufficient pattern width to be ensured for each line that passes through the second section.

Assuming that the length of the first side is L1 and that the winding width of the first coil pattern is W, L1/W=0.8 to 1.2 may be satisfied. This can reduce an AC resistance value and the size of the coil pattern. Assuming that the length of the second side is L2, L1/L2=2.8 to 3.4 may be satisfied. Further, assuming that length of the opening area in a second direction orthogonal to the first direction is h, W/h=1.2 to 1.6 may be satisfied. This can enhance an inter-coil coupling coefficient k.

Each turn constituting the first coil pattern may be divided into a plurality of lines. This can reduce an AC resistance value.

The coil component may further include a substrate on one surface of which the first coil pattern is formed, a second coil pattern and a dummy pattern which are formed on the other surface of the substrate. The inner peripheral end of the first coil pattern and the inner peripheral end of the second coil pattern may be connected to each other through a first through-hole conductor penetrating the substrate, and the outer peripheral end of the first coil pattern and the dummy pattern may be connected to each other through a second through-hole conductor penetrating the substrate. With this configuration, the outer peripheral end of the first coil pattern is more firmly fixed to the surface of the substrate, so that peeling is less likely to occur.

A mobile terminal holder according to one embodiment of the present disclosure includes a main body part having a placing surface on which a mobile terminal is placed, a lower stopper against which the mobile terminal placed on the placing surface abuts at its lower end by its own weight for positioning, and the above-described coil component incorporated in the main body part so as to locate the first side on the lower stopper side and to locate the second side on the side opposite to the lower stopper.

With the above-described mobile terminal holder, a high magnetic coupling degree can be obtained irrespective of the size and position of the mobile terminal.

### Examples

With the coil component 30 having the structure illustrated in FIGS. 3 to 5 used as a power transmitting coil and with a circular coil having an inner diameter of 20 mm and an outer diameter of 40 mm used as a power receiving coil, simulations were performed for characteristics when the length L1 of the lower side 401, length L2 of the upper side 402 and height h of the opening area 400 were varied. The distance between the power transmitting coil and power receiving coil in the z-direction was set to 4 mm.

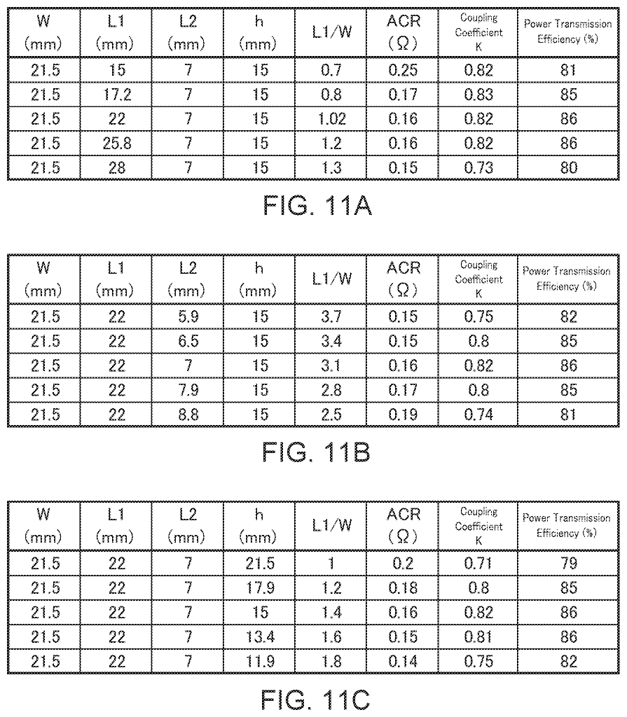

FIG. 11A is a table showing characteristics when the length L1 is changed. In this example, the power receiving coil shifts by 4 mm and 10 mm in the negative y-direction and positive x-direction, respectively, from the center of the power transmitting coil. As illustrated in FIG. 11A, when the value of L1/W falls within the range of 0.8 to 1.2, a power transmission efficiency of 85% or more is obtained.

FIG. 11B is a table showing characteristics when the length L2 is changed. In this example, the power receiving coil shifts by 4 mm and 4 mm in the negative y-direction and positive x-direction, respectively, from the center of the power transmitting coil. As illustrated in FIG. 11B, when the value of L1/L2 falls within the range of 2.8 to 3.4, a power transmission efficiency of 85% or more is obtained.

FIG. 11C is a table showing characteristics when the height h is changed. In this example, the power receiving coil shifts by 4 mm and 4 mm in the negative y-direction and positive x-direction, respectively, from the center of the power transmitting coil. As illustrated in FIG. 11C, when the value of W/h falls within the range of 1.2 to 1.6, a power transmission efficiency of 85% or more is obtained.

What is claimed is:

1. A coil component comprising a first coil pattern,
wherein an opening area surrounded by the first coil pattern has a first side extending in a first direction and a second side extending in the first direction, and
wherein the first side is longer than the second side.

2. The coil component as claimed in claim 1,
wherein the opening area further has a third side connecting one end of the first side and one end of the second side and a fourth side connecting other end of the first side and other end of the second side, and
wherein an angle formed by the first and third sides is equal to an angle formed by the first and fourth sides.

3. The coil component as claimed in claim 2,
wherein each turn constituting the first coil pattern has a first section extending along the second, third, and fourth sides and a second section extending along the first side,
wherein the first section extends in parallel to the second, third, and fourth sides, and
wherein the second section has a part that extends obliquely to the first side.

4. The coil component as claimed in claim 3, wherein a length of the part that extends obliquely along the first side is larger than a winding width of each turn constituting the first coil pattern.

5. The coil component as claimed in claim 1, wherein, assuming that a length of the first side is L1 and that a winding width of the first coil pattern is W, L1/W=0.8 to 1.2 is satisfied.

6. The coil component as claimed in claim 5, wherein, assuming that a length of the second side is L2, L1/L2=2.8 to 3.4 is satisfied.

7. The coil component as claimed in claim 5, wherein, assuming that a length of the opening area in a second direction orthogonal to the first direction is h, W/h=1.2 to 1.6 is satisfied.

8. The coil component as claimed in claim 1, wherein, each turn constituting the first coil pattern is divided into a plurality of lines.

9. The coil component as claimed in claim 1, further comprising:
a substrate on one surface of which the first coil pattern is formed; and
a second coil pattern and a dummy pattern which are formed on other surface of the substrate,
wherein an inner peripheral end of the first coil pattern and an inner peripheral end of the second coil pattern are connected to each other through a first through-hole conductor penetrating the substrate, and
wherein an outer peripheral end of the first coil pattern and the dummy pattern are connected to each other through a second through-hole conductor penetrating the substrate.

10. A mobile terminal holder comprising:
a main body part having a placing surface on which a mobile terminal is placed;
a lower stopper against which the mobile terminal placed on the placing surface abuts at its lower end by its own weight for positioning; and
a coil component including a first coil pattern,
wherein an opening area surrounded by the first coil pattern has a first side extending in a first direction and a second side extending in the first direction,
wherein the first side is longer than the second side, and
wherein the coil component is incorporated in the main body part so as to locate the first side on the lower stopper side and to locate the second side on a side opposite to the lower stopper.
